(19) United States
(12) Patent Application Publication
(10) Pub. No.: US 2014/0078071 A1
(43) Pub. Date: Mar. 20, 2014

(54) Stylus Attachment for Writing Utensils

(71) Applicants: Christian Walsh, Cedar Park, TX (US); Gabriel Haro, Cedar Park, TX (US)

(72) Inventors: Christian Walsh, Cedar Park, TX (US); Gabriel Haro, Cedar Park, TX (US)

(21) Appl. No.: 13/620,817

(22) Filed: Sep. 15, 2012

(51) Int. Cl. G06F 3/041

(52) U.S. Cl. 345/173

(57) ABSTRACT

A stylus attachment for writing utensils to manipulate touch screen devices. The stylus attachment comprises a hollow cylindrical shaft member and a stylus tip member which is secured to the hollow cylindrical shaft member with an adhesive. The stylus attachment Is attached to a writing utensil or alternative object by inserting the writing utensil or alternative object into the hollow cylindrical shaft member of the present inversion. The present invention is made of foam, rubber, or plastic and can be made m a variety of sizes and color preferable to the user. The present invention allows users to use a writing utensil for both writing on conventional media and manipulating a touch screen, eliminating the need, for example, to set down a pencil and pick up a stylus.

### BACKGROUND OF THE INVENTION

1. Field of the Invention

The present Invention relates generally to the field of computers and personal computing devices having touch screens and specifically to a stylus attachable to writing utensils for manipulation of devices with touch screen capabilities.

2. Description of the Prior Art

Touch screen tablets, phones, PDAs, and similar devices are typically equipped with small keys. This requires the user to peck at keys with fingers far larger than the keys. The stylus has been used for increased precision when Inputting data into touch screen devices but it can be expensive and inconvenient. Users, especially those who use these devices to take notes, input data, and perform calculations, experience inconvenience when they must set down their stylus to pick a writing utensil to perform a non-electronic operation. It would be advantageous to have a stylus capable of fitting onto a writing utensil so the user can write and manipulate the touch screen without setting down their stylus or writing utensil.

### SUMMARY OF THE INVENTION

The present invention relates to a stylus attachment for standard writing utensils to manipulate touch screen devices. The present invention can include a hollow cylindrical shaft made of foam, rubber, or plastic. The present invention can also include a stylus tip_ made or foam, rubber, or plastic. The stylus tip member can fit onto one end of the hollow cylindrical shaft member and be secured with an adhesive. The unoccupied end of the hollow cylindrical shaft member can slide over the extremities of a writing utensil and remain so until removed. The said Stylus Attachment for Writing Utensils eliminates the cost of a standard size stylus and the user's need to set the stylus down in order to pick up a writing utensil.

### DESCRIPTION OF DRAWING VIEWS

FIG. 1 is a frontal explosion view of the stylus attachment assembly.

FIG. 2 is a frontal view of stylus attachment.

FIG. 3 is a side explosion view of the present invention being attached to a pencil.

FIG. 4 is a side view of the present invention while secured to a pencil.

FIG. 5 is a bottom fight Isometric view to show the hollow nature of the hollow cylindrical shaft member.

FIG. 6 is a top right Isometric view to show the rounded, ellipsoid nature of the stylus tip member.

### DETAILED DESCRIPTION OF THE INVENTION

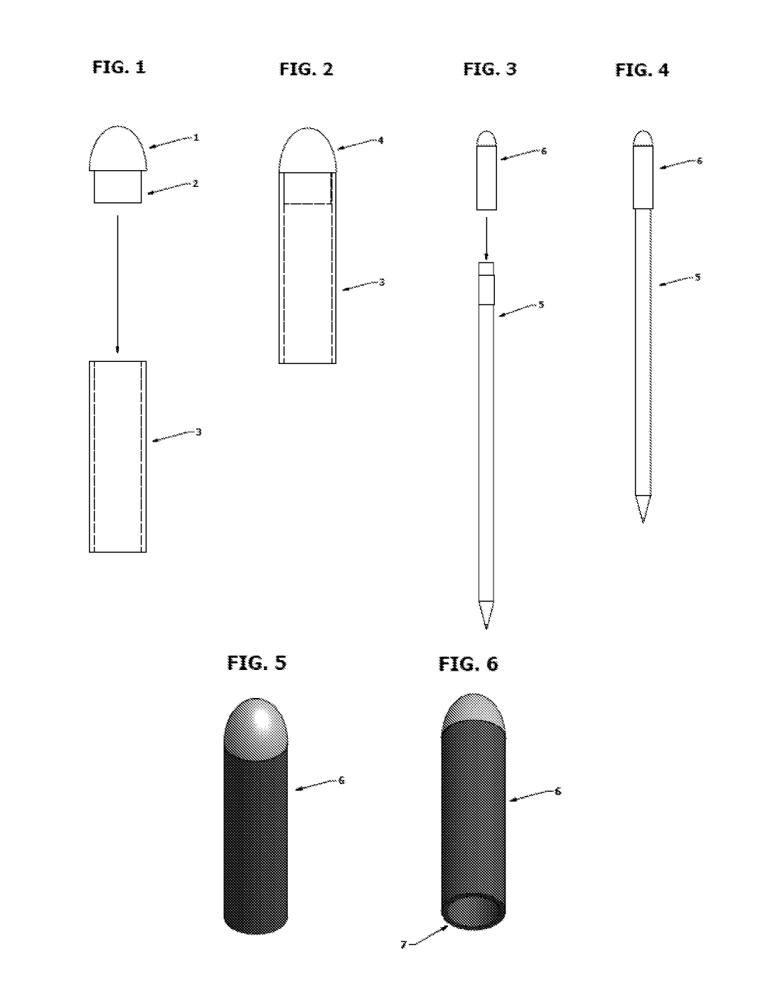

Referring to FIGS. 1 and 2, the preferred embodiment of the present invention consists of a hollow cylindrical shaft member, 3, and a stylus tip member, 4. The stylus tip member, 4, is composed of an ellipsoid portion, 1, and a cylindrical protrusion portion, 2. The ellipsoid portion, 1, is the portion of the stylus attachment for writing utensils that contacts touch screens and is used to manipulate data. The cylindrical protrusion portion, 2, is designed to fit inside the hollow cylindrical shaft member, 3, and be secured with an adhesive so that the ellipsoid portion, 1, protrudes from the hollow cylindrical shaft member, 3. FIG. 1 shows a frontal explosion view of the how the hollow cylindrical shaft member, 3, and the stylus tip member, 4, are to he joined when assembled. FIG. 2 shows a frontal view of the assembled invention consisting of the hollow cylindrical shaft member, 3, and the stylus tip member, 4.

As shown in FIG. 6, the hollow cylindrical shaft member, 3, has an inner wall, 7, that can surround an extremity of a writing utensil. FIGS. 5 and 6 show the present invention, the Stylus Attachment for Writing Utensils, 6. FIG. 3 shows how the present invention can be attached to a writing utensil such as a pencil, 5. To attach the Stylus Attachment for Writing Utensils, 6, a user should insert a writing utensil, 5, into the hollow cylindrical shaft member, 3, until it contacts the stylus tip member, 4. FIG. 4 shows the present invention, 6, attached to a writing utensil, 5.

The preferred embodiment of the hollow cylindrical shaft member, 3, can be made of foam, rubber, or plastic and is not limited to any specific color or size. The preferred embodiment of the stylus tip member, 4, can also be made of foam, rubber, or plastic and is also not limited to any specific color or size. The present invention can be attached to, but is not limited to, sticks, users' fingers, hardware such as screws, nails, and rivets, office supplies such as papers clips, binder clips, and flash drives, and writing utensils such as pens, pencils, markers, crayons, and fountain pens. Variations to the present invention can be made such as, but not limited to, constructing the present invention from a single piece of material. Constructing the present invention from a single piece of material is not the preferred embodiment of present invention because it restricts the variable number of color and material combinations but it is acceptable. The present invention can interact with all types of touch screens, such as, but not limited to, capacitative touch screens, optical touch screens. Infrared touch screens, and acoustic pulse touch screens. The claims we have set forth below define the scope of the invention.

What we claim is:

1. A stylus attachment for writing utensils to manipulate touch screen devices comprising a hollow cylindrical shaft member and a stylus tip member, wherein said stylus tip member is composed of an ellipsoid portion and a cylindrical protrusion portion, wherein said cylindrical protrusion fits into said hollow cylindrical shaft member.

2. The stylus attachment for writing utensils as set forth in claim 1, wherein said device is assembled by inserting said cylindrical protrusion portion of said stylus tip member Into said cylindrical shaft member and secured with an adhesive.

3. The stylus attachment for writing utensils as set forth in claim 1, wherein said hollow cylindrical shaft member is made of foam, rubber, or plastic.

4. The stylus attachment for writing utensils as set forth in claim 1, wherein said hollow cylindrical shaft member can be made in any shape and/or color preferable to the user or size sufficiently large enough to accommodate a variety of writing utensils and/or alternative objects.

5. The stylus attachment for writing utensils as set forth in claim 1, wherein said stylus tip member is made of foam, rubber, or plastic.

6. The stylus attachment for writing utensils as set forth in claim 1, wherein said stylus tip member can be made in any size to fit the said hollow cylindrical shaft member and in any shape or color preferable to the user.

7. The stylus attachment for writing utensils as set forth in claim 1, wherein said device can manipulate all types of touch screens such as, but not limited to, capacitative, optical, infrared, and/or acoustic pulse touch screens.

8. The stylus attachment for writing utensils as set forth in claim 1, wherein said device can conduct electricity to allow it to interact with any type of touch screen requiring electricity such as, but not limited to, capactative touch screens.

9. The stylus attachment for writing utensils as set forth in claim 1, wherein said device can be attached to any writing utensil such as, but not limited to, pens, pencils, markers, crayons, highlighters, and fountain pens, as well as any alternative object such as, but not limited to, users' fingers, sticks, kitchen/dining utensils, gloves, hardware such as, but not limited to, screws, nails, and rivets, and office supplies such as, but not limited to, paper clips, binder clips, and rulers.

10. The stylus attachment for writing utensils as set forth in claim 1, wherein said device is attached to a writing utensil or alternative object by inserting an extremity of the object into the unoccupied end of said hollow cylindrical shaft member.

11. The stylus attachment for writing utensils to manipulate touch screens can be constructed from a single piece of material, comprising a hollow cylindrical shaft portion and a hollow ellipsoid portion.

12. The stylus attachment for writing utensils as set forth in claim 8, wherein said hollow cylindrical shaft portion is unoccupied at one extremity and transitions into the hollow ellipsoid portion at the other extremity.

13. The stylus attachment for writing utensils as set forth in claim 8 is made of foam, rubber, or plastic.

14. The stylus attachment for writing utensils as set forth in claim 8 can be made in any size, shape, and/or color preferable to the user and in any size sufficiently large enough to accommodate a variety of writing utensils and/or alternative objects.

15. The stylus attachment for writing utensils as set forth in claim 8, wherein said device can manipulate all types of touch screens such as, but not limited to, capacitative, optical, infrared, and/or acoustic pulse touch screens.

16. The stylus attachment for writing utensils as set forth in claim 8, wherein said device can conduct electricity to allow it to interact with any type of touch screen requiring electricity such as, but not limited to, capacitative touch screens.

17. The stylus attachment for writing utensils as set forth in claim 8 is attached to a writing utensil by inserting an extremity of the writing utensil into the unoccupied end of said stylus attachment.
